(19) United States
(12) Patent Application Publication
(10) Pub. No.: US 2012/0072936 A1
(43) Pub. Date: Mar. 22, 2012

(54) Automatic Customized Advertisement Generation System

(75) Inventors: Sheridan Martin Small, Seattle, WA (US); Andrew Fuller, Redmond, WA (US); Avi Bar-Zeev, Redmond, WA (US); Kathryn Stone Perez, Kirkland, WA (US)

(73) Assignee: MICROSOFT CORPORATION, Redmond, WA (US)

(21) Appl. No.: 12/886,141

(22) Filed: Sep. 20, 2010

(51) Int. Cl. H04H 60/33; H04N 7/025

(52) U.S. Cl. 725/10; 725/34

(57) ABSTRACT

A system for generating a customized advertisement for a user is provided. Multimedia content associated with a current broadcast is received and displayed. The multimedia content may include recorded video content, video-on-demand content, television content, television programs, advertisements, commercials, music, movies, video clips, and other on-demand media content. One or more users are identified in a field of view of a capture device connected to a computing device. User-specific information related to a user is tracked. An emotional response of a user to the multimedia content viewed by the user is tracked. A targeted advertisement is provided to a user based on the multimedia content viewed by the user, the user's identification information and the user's emotional response. The targeted advertisement is automatically customized based on the user-specific information related to the user to generate a customized advertisement for the user. The targeted and customized advertisement is displayed to the user during a pre-programmed time interval, via an audiovisual device connected to the computing device.

### BACKGROUND

Advertising is a form of communication intended to persuade an audience to purchase or take some action on a product or service. Advertisements may appear between shows such as a television program, a movie or a sporting event and may typically interrupt the show at regular intervals. The goal of advertisers is to keep a viewer's attention focused on a commercial or advertisement, but often the viewer is engaged in other activities during the commercial to avoid watching the commercial. Viewers often do not pay attention to advertisements because the advertisements are not personal, relevant or even relatable to the viewers.

### SUMMARY

Disclosed herein is a method and system that automatically generates a targeted advertisement and/or customized advertisement for a user based on user-specific information and/or a user's emotional response to multimedia content viewed by the user. User-specific information may include information related to one or more aspects of the user's life such as the user's expressed preferences, the user's friends' list, the user's stated preferred activities, the user's friends' expressed preferences, the user's social groups and other user created content, such as the user's photos, images and recorded videos. An emotional response to the multimedia content viewed by a user may be automatically tracked by detecting the user's facial expressions, sounds, gestures and movements while viewing multimedia content. In one embodiment, a targeted advertisement is provided to the user based on the user's emotional response, the user's identity and the multimedia content viewed by the user. In another embodiment, the targeted advertisement is automatically customized to generate a customized advertisement for the user. In one embodiment, the customized advertisement displays information about one or more aspects of the user's life in the advertisement based on the user-specific information related to the user, thereby enhancing the user's affinity to the product being displayed in the advertisement. The targeted advertisement or the customized advertisement is displayed to the user via an audiovisual device.

In one embodiment, multimedia content associated with a current broadcast is received and displayed. One or more users are identified in a field of view of a capture device connected to a computing device. User-specific information for the users is tracked. An emotional response of the users to the multimedia content viewed by the users is tracked. Information identifying the multimedia content viewed by the users, information identifying the users and the emotional response of the users to the viewed multimedia content is provided to a remote computing system for analysis. A targeted advertisement for the users is received based on the analysis. The targeted advertisement is automatically customized to generate a customized advertisement for the users. The customized advertisement is displayed to the users during a pre-programmed time interval, via an audiovisual device connected to the computing device.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates one embodiment of a target recognition, analysis and tracking system for performing the operations of the disclosed technology.

FIG. 2 illustrates one embodiment of a capture device that may be used as part of the tracking system.

FIG. 3 illustrates an example of a computing device that may be used to implement the computing device of FIG. 1-2.

FIG. 4 illustrates a general purpose computing device which can be used to implement another embodiment of computing device 12.

FIG. 5 illustrates another embodiment of the computing device for implementing the operations of the disclosed technology.

FIG. 6 illustrates an embodiment of a system for implementing the present technology.

FIG. 7 is a flowchart describing one embodiment of a process for providing targeted and/or customized advertisements.

FIG. 8 is a flowchart describing one embodiment of a process for customizing advertisements.

FIG. 9 is a flowchart describing one embodiment of a process for tracking user-specific information.

### DETAILED DESCRIPTION

Technology is disclosed by which a targeted advertisement and/or customized advertisement is automatically generated for a user based on user-specific information and/or a user's emotional response to multimedia content viewed by the user A capture device captures one or more users viewing multimedia content via an audiovisual device. The output of the capture device is used to automatically track the user's emotional response to the multimedia content being viewed by the user by detecting the user's facial expressions, audio responses, movements or gestures while viewing the multimedia content. A computing device uniquely identifies one or more users captured by the capture device and automatically tracks user-specific information for the users. The computing device provides information about the user's identification, the multimedia content viewed by the user and/or the user's movements, gestures and most recent facial expression while viewing the multimedia content to a remote computing system for analysis. The remote computing system selects an advertisement to be targeted to the user based on information provided by the computing system. The computing system displays a targeted advertisement to the user via the audiovisual device. In one embodiment, the computing system automatically customizes the targeted advertisement received from the remote computing system to generate a customized advertisement to the user. In one embodiment, the computing system utilizes the user-specific information related to the user such as the user's expressed preferences, the user's friends' list, the user's stated preferred activities, the user's friends' expressed preferences, the user's social groups and other user created content, such as the user's photos, images and recorded videos to generate the customized advertisement to the user. The customized advertisement is displayed to the user via an audiovisual device.

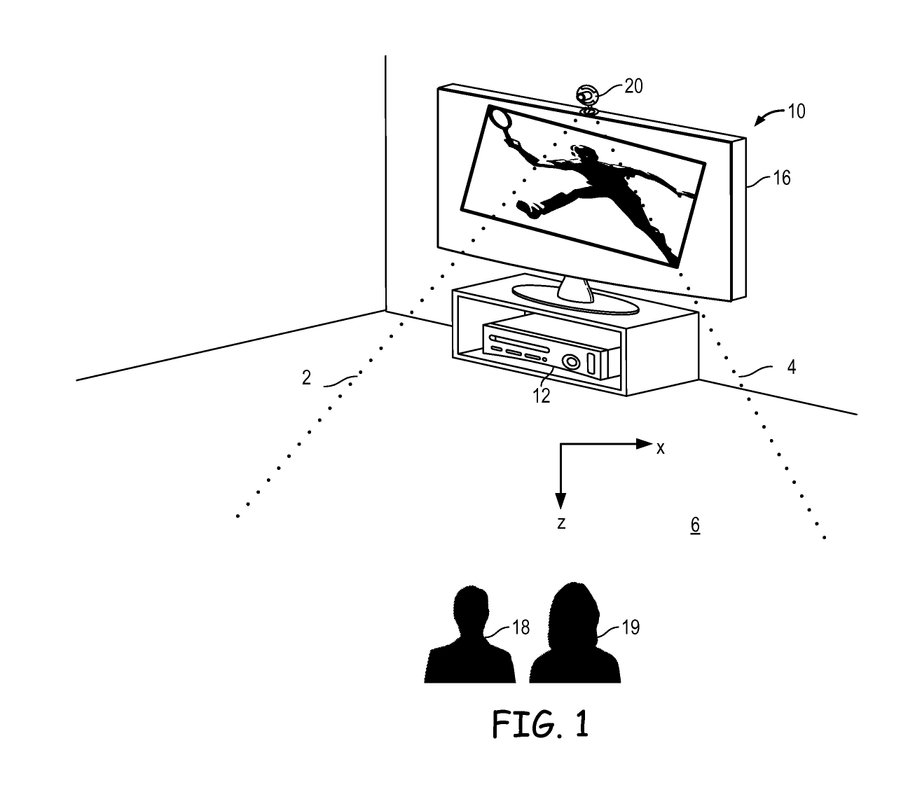

FIG. 1 illustrates one embodiment of a target recognition, analysis and tracking system 10 (generally referred to as a tracking system hereinafter) for performing the operations of the disclosed technology. The target recognition, analysis and tracking system 10 may be used to recognize, analyze, and/or track one or more human targets such as users 18 and 19. As shown in FIG. 1, the tracking system 10 may include a computing device 12. In one embodiment, computing device 12 may be implemented as any one or a combination of a wired and/or wireless device, as any form of television client device (e.g., television set-top box, digital video recorder (DVR), etc.), personal computer, portable computer device, mobile computing device, media device, communication device, video processing and/or rendering device, appliance device, gaming device, electronic device, and/or as any other type of device that can be implemented to receive media content in any form of audio, video, and/or image data. According to one embodiment, the computing device 12 may include hardware components and/or software components such that the computing device 12 may be used to execute applications such as gaming applications, non-gaming applications, or the like. In one embodiment, computing device 12 may include a processor such as a standardized processor, a specialized processor, a microprocessor, or the like that may execute instructions stored on a processor readable storage device for performing the processes described herein.

As shown in FIG. 1, the tracking system 10 may further include a capture device 20. The capture device 20 may be, for example, a camera that may be used to visually monitor one or more users, such as users 18 and 19, such that movements and gestures performed by the users and audio responses from the users may be captured and tracked by the capture device 20.

According to one embodiment, computing device 12 may be connected to an audiovisual device 16 such as a television, a monitor, a high-definition television (HDTV), a mobile computing device or the like that may provide visuals and/or audio to users 18 and 19. For example, the computing device 12 may include a video adapter such as a graphics card and/or an audio adapter such as a sound card that may provide the audiovisual signals to a user. The audiovisual device 16 may receive the audiovisual signals from the computing device 12 and may output visuals and/or audio associated with the audiovisual signals to users 18 and 19. According to one embodiment, the audiovisual device 16 may be connected to the computing device 12 via, for example, an S-Video cable, a coaxial cable, an HDMI cable, a DVI cable, a VGA cable, or the like.

In one embodiment, capture device 20 detects one or more users, such as users 18, 19 within a field of view, 6, of the capture device and tracks an emotional response to multimedia content being viewed by the users via the audio visual device 16. Lines 2 and 4 denote a boundary of the field of view 6. Multimedia content can include any type of audio, video, and/or image media content received from media content sources such as content providers, broadband, satellite and cable companies, advertising agencies the internet or video streams from a web server. As described herein, multimedia content can include recorded video content, video-on-demand content, television content, television programs, advertisements, commercials, music, movies, video clips, and other on-demand media content. Other multimedia content can include interactive games, network-based applications, and any other content or data (e.g., program guide application data, user interface data, advertising content, closed captions, content metadata, search results and/or recommendations, etc.). The operations performed by the capture device 20 are discussed in detail below.

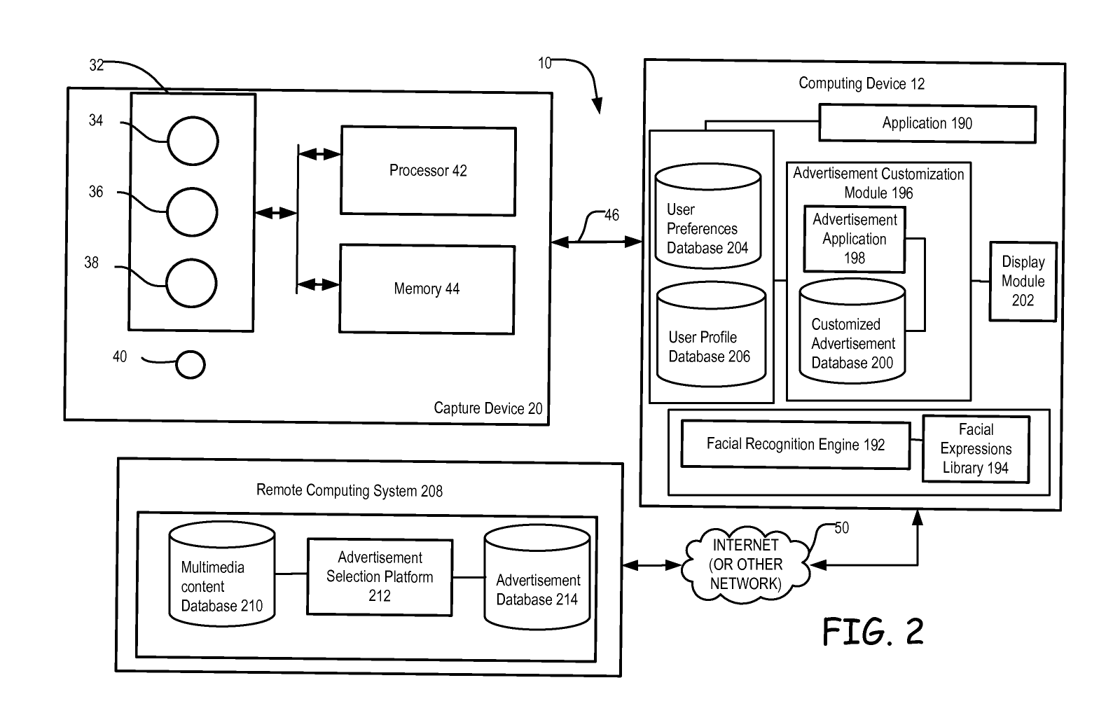

FIG. 2 illustrates one embodiment of a capture device 20 and computing device 12 that may be used in the target recognition, analysis and tracking system 10 to recognize human and non-human targets in a capture area and uniquely identify them and track them in three dimensional space. According to one embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z-axis extending from the depth camera along its line of sight.

As shown in FIG. 2, the capture device 20 may include an image camera component 32. According to one embodiment, the image camera component 32 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 2, the image camera component 32 may include an IR light component 34, a three-dimensional (3-D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more targets and objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

According to one embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more targets or objects in the capture area, the pattern may become deformed in response. Such a deformation of the pattern may be captured by, for example, the 3-D camera 36 and/or the RGB camera 38 and may then be analyzed to determine a physical distance from the capture device to a particular location on the targets or objects.

According to one embodiment, the capture device 20 may include two or more physically separated cameras that may view a capture area from different angles, to obtain visual stereo data that may be resolved to generate depth information. Other types of depth image sensors can also be used to create a depth image.

The capture device 20 may further include a microphone 40. The microphone 40 may include a transducer or sensor that may receive and convert sound into an electrical signal. According to one embodiment, the microphone 40 may be used to reduce feedback between the capture device 20 and the computing device 12 in the target recognition, analysis and tracking system 10. Additionally, the microphone 40 may be used to receive audio signals that may also be provided by the user to control an application 190 such as a game application or a non-game application, or the like that may be executed by the computing device 12.

In one embodiment, capture device 20 may further include a processor 42 that may be in operative communication with the image camera component 32. The processor 42 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction.

The capture device 20 may further include a memory component 44 that may store the instructions that may be executed by the processor 42, images or frames of images captured by the 3-D camera or RGB camera, user profiles or any other suitable information, images, or the like. According to one example, the memory component 44 may include random access memory (RAM), read only memory (ROM), cache, Flash memory, a hard disk, or any other suitable storage component. As shown in FIG. 2, the memory component 44 may be a separate component in communication with the image capture component 32 and the processor 42. In another embodiment, the memory component 44 may be integrated into the processor 42 and/or the image capture component 32. In one embodiment, some or all of the components 32, 34, 36, 38, 40, 42 and 44 of the capture device 20 illustrated in FIG. 2 are housed in a single housing.

The capture device 20 may be in communication with the computing device 12 via a communication link 46. The communication link 46 may be a wired connection including, for example, a USB connection, a Firewire connection, an Ethernet cable connection, or the like and/or a wireless connection such as a wireless 802.11b, g, a, or n connection. The computing device 12 may provide a clock to the capture device 20 that may be used to determine when to capture, for example, a scene via the communication link 46.

The capture device 20 may provide the depth information and images captured by, for example, the 3-D (or depth) camera 36 and/or the RGB camera 38, including a skeletal model that may be generated by the capture device 20, to the computing device 12 via the communication link 46. The computing device 12 may then use the skeletal model, depth information and captured images to control an application 190 such as a game application or a non-game application, or the like that may be executed by the computing device 12.

In one embodiment, capture device 20 may capture one or more users viewing multimedia content via the audiovisual device connected to the computing device 12 in a field of view, 6, of the capture device, and track the users' emotional response to the multimedia content being viewed. In one embodiment, computing device 12 may utilize the images captured by the capture device 20 in an advertisement customization module 196 in the computing device 12. The advertisement customization module 196 may provide a targeted advertisement and/or customized advertisement to one or more users viewing the multimedia content based on the images captured by the capture device. The operations performed by the capture device and the computing device are discussed in detail below.

In one embodiment, multimedia content associated with a current broadcast is initially received from one or more media content sources such as content providers, broadband, satellite and cable companies, advertising agencies, the internet or video streams from a web server. The multimedia content may be received at the computing device 12 or at the audiovisual device 16 connected to the computing device 12. The multimedia content can include recorded video content, video-on-demand content, television content, television programs, advertisements, commercials, music, movies, video clips and other on-demand media content. The multimedia content may be received over a variety of networks. Suitable types of networks that may be configured to support the provisioning of multimedia content services by a service provider may include, for example, telephony-based networks, coaxial-based networks and satellite-based networks. In one embodiment, the multimedia content may be displayed via the audiovisual device 16 to the users.

In one embodiment, the multimedia content associated with the current broadcast is then identified. For example, the multimedia content may be identified to be a television program, movie, a live performance or a sporting event. For example, the multimedia content may be identified to be a television program by identifying the channel and the program that the television set is tuned to during a specific time slot from metadata embedded in the content stream or from an electronic program guide provided by a service provider. In one embodiment, the audio visual device 16 may identify the multimedia content associated with the current broadcast. Alternatively, the computing device 12 may also identify the multimedia content associated with the current broadcast.

In one embodiment, capture device 20 initially captures one or more users viewing multimedia content in a field of view, 6, of the capture device. Capture device 20 provides a visual image of the captured users to the computing device 12. Computing device 12 performs the identification of the users captured by the capture device 20. In one embodiment, computing device 12 includes a facial recognition engine 192 to perform the identification of the users. Facial recognition engine 192 may correlate a user's face from the visual image received from the capture device 20 with a reference visual image to determine the user's identity. In another example, the user's identity may be also determined by receiving input from the user identifying their identity. In one embodiment, users may be asked to identify themselves by standing in front of the computing system 12 so that the capture device 20 may capture depth images and visual images for each user. For example, a user may be asked to stand in front of the capture device 20, turn around, and make various poses. After the computing system 12 obtains data necessary to identify a user, the user is provided with a unique identifier and password identifying the user. More information about identifying users can be found in U.S. patent application Ser. No. 12/696,282, “Visual Based Identity Tracking” and U.S. patent application Ser. No. 12/475,308, “Device for Identifying and Tracking Multiple Humans over Time,” both of which are incorporated herein by reference in their entirety. In another embodiment, the user's identity may already be known by the computing device when the user logs into the computing device, such as, for example, when the computing device is a mobile computing device such as the user's cellular phone.

In one embodiment, the user's identification information may be stored in a user profile database 206 in the computing device 12. The user profile database 206 may include information about the user such as a unique identifier and password associated with the user, the user's name and other demographic information related to the user such as the user's age group, gender and geographical location, in one example. In one embodiment, computing device 12 may automatically track user-specific information related to one or more of the users detected by the capture device 20. User-specific information may include information about one or more aspects of the user's life such as the user's expressed preferences, the user's friends' list (which may be optionally provided by the user), the user's stated preferred activities, the user's friends' expressed preferences, the user's social groups and other user created content, such as the user's photos, images and recorded videos, derived from one or more data sources such as the user's social networking sites, or the internet, in one example. In one embodiment, the disclosed technology may provide a mechanism by which a user's privacy concerns are met by protecting, encrypting or anonymizing some or all of the user-specific information before implementing the disclosed technology. User-specific information may also include demographic information related to the user and the user's emotional response to multimedia content viewed by the user which may be obtained from the user profile database 206. User-specific information may also include additional information about the user such as the user's game-related information derived from one or more game applications 190 executing in the user's computing device 12. Game-related information may include information about the user's on-screen character representation, the user's statistics for particular games, achievements acquired for particular games, and/or other game specific information.

The user-specific information may be stored in a user preferences database 204 in the computing device 12, in one embodiment. In an alternate embodiment, all or some of the user-specific information may also be stored in a user preferences database in one or more processing devices utilized by the user at run time, which may include, for example, the user's console, personal computer or mobile computing device. In one embodiment, the user preferences database 204 may be implemented as a table with fields representing the various types of user-specific information. An exemplary illustration of a user-specific information table is illustrated in Table-1 as shown below:

TABLE 1
User-specific Information Table

| | | Stated | | | | Game- |
|---|---|---|---|---|---|---|
| | Expressed | Preferred | | | Recorded | Related |
| Friend List | Preferences | Activities | Photos | Images | Videos | Information |
| {Friend 1 . . . | TV shows, | Skiing, | User1.jpg, | Yellowstonepark.jpg | Video1.wma | UserAvatar.jpg |
| FriendN} | books, | Whitewater | family.jpg, | | | |
| | movies | river | friends.jpg | | | |
| | | rafting | | | | |

In one example, computing device 12 may perform the tracking of the user-specific information on a periodic basis or at pre-programmed intervals of time which may be determined by the computing device 12, in one embodiment. In one embodiment, the disclosed technology may also provide a mechanism by which a user's privacy concerns are met by obtaining a user's consent prior to the gathering of the user-specific information, via a user opt-in process before implementing the disclosed technology. In one example, the user opt-in process may include prompting a user to select an option displayed via the audio visual device 16 connected to the computing device 12. The option may display text such as, “Do you consent to the gathering of information related to you?” The option may be displayed to the user during initial set up of the user's system, in one example. In another example, the option may be displayed to the user each time the user logs into the system.

In another embodiment, capture device 20 may automatically track a user's emotional response to the multimedia content being viewed by the user by detecting the user's facial expressions and/or vocal responses to the multimedia content. In one example, capture device 20 may detect facial expressions and/or vocal responses such as smiles, laughter, cries, frowns, yawns or applauses from the user. In one embodiment, the facial recognition engine 192 in the computing device 12 may identify the facial expressions performed by a user by comparing the data captured by the cameras 36, 38 (e.g., depth camera and/or visual camera) in the capture device 20 to one or more facial expression filters in a facial expressions library 194 in the facial recognition engine 192. Facial expressions library 194 may include a collection of facial expression filters, each comprising information concerning a user's facial expression. In another example, facial recognition engine 192 may also compare the data captured by the microphone 40 in the capture device 20 to the facial expression filters in the facial expressions library 194 to identify one or more vocal responses, such as, for example, sounds of laughter or applause associated with a facial expression.

In one embodiment, capture device 20 may also track a user's emotional response to the multimedia content being viewed by tracking the user's gestures and movements while viewing the multimedia content. In one example, movements tracked by the capture device may include detecting if a user moves away from the field of view of the capture device 20 or stays within the field of view of the capture device 20 while viewing the multimedia content. Gestures tracked by the capture device 10 may include detecting a user's posture while viewing the multimedia program such as, if the user turns away from the audio visual device 16, faces the audio visual device 16 or leans forward or talks to the display device (e.g., by mimicking motions associated with an activity displayed by the multimedia content) while viewing the multimedia content. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009, both of which are incorporated by reference herein in their entirety.

The user's facial expressions, vocal responses, movements and gestures may be stored in the user profile database 206, in one embodiment. In one example, the tracking and identification of a user's facial expressions, vocal responses, movements and gestures may be performed at pre-programmed intervals of time, while the user views the multimedia content. The pre-programmed intervals of time may be determined by the computing device 12. It is to be appreciated that the tracking and identification of a user's facial expressions, movements and gestures at pre-programmed intervals of time enables the determination of the user's emotional response to the viewed multimedia content at different points in time. In one embodiment, the disclosed technology may provide a mechanism by which a user's privacy concerns are met while interacting with the target recognition and analysis system 10. In one example, an opt-in by the user to the tracking of the user's facial expressions, movements and gestures while the user views multimedia content is obtained from the user before implementing the disclosed technology. The opt-in may display an option with text such as, “Do you consent to the tracking of your movements, gestures and facial expressions?” As discussed above, the option may be displayed to the user during initial set up of the user's system or each time the user logs into the system.

In one embodiment, computing device 12 includes an advertisement customization module 196. The advertisement customization module 196 includes an advertisement application 198 and a customized advertisement database 200. Advertisement customization module 196 may be implemented as a software module to perform one or more operations of the disclosed technology. In one embodiment, advertisement application 198 in the advertisement customization module 196 may provide a targeted advertisement or a customized advertisement to a user, while the user views multimedia content via the audiovisual device 16. The operations performed by the advertisement application 198 are discussed in detail below.

In one embodiment, advertisement application 198 may receive user-specific information about a user, such as, for example, the user's identification, the multimedia content viewed by the user, the user's most recent facial expression, movements and gestures while viewing the multimedia content from the computing device and the capture device as discussed above and provide this information to a remote computing system 208 for analysis. In one embodiment, advertisement application 198 may anonymize the user's identification information prior to providing the user's identification information to the remote computing system 208 so that the user's privacy concerns are met. Remote computing system 208 may represent a content provider or an advertiser, in one embodiment. Computing system 12 may be coupled to the remote computing system 208 via a network 50. Network 50 may be a public network, a private network, or a combination of public and private networks such as the Internet. In an alternate embodiment, the application 190, the facial recognition engine 192, and the advertisement customization module 196 in the computing device 12 may also be implemented as software modules in the remote computing system 208, to perform one or more operations of the disclosed technology.

In one embodiment, remote computing system 208 may include a multimedia content database 210, an advertisement database 214 and an advertisement selection platform 212. Multimedia content database 210 may include multimedia content such as recorded video content, video-on-demand content, television content, television programs, music, movies, video clips, and other on-demand media content. Advertisement database 214 may include a list of advertisements or commercials associated with the different types of multimedia content that may be streamed to a user.

Advertisement selection platform 212 selects an advertisement to be displayed to a user based on analyzing the information received from the computing system 12. In one embodiment, the selected advertisement is a targeted advertisement that is provided to the user based on the user's identification information, the multimedia content viewed by the user and the user's facial expression. For example, if the user's identification information indicates that the user is a female belonging to a certain age group, the advertisement selection platform 212 may select an advertisement that is targeted to a female audience, in one example. Or, for example, if the user's facial expression indicates that the user is happy, the advertisement selection platform 212 may select an advertisement that makes the user laugh. If, for example, the user's identification information indicates that the user is a male belonging to a certain age group, the advertisement selection platform 212 may select an advertisement that is targeted to a male audience.

In another embodiment, the computing device 12 may provide information about a group of users identified by the computing device 12 to the remote computing system 208. Advertisement selection platform 212 may select an advertisement to be displayed to the group of users based on analyzing information received from the computing system 12. For example, if the group of identified users includes an adult male in the age group 30-35, an adult female in the age group 30-35 and a child, then the advertisement selection platform 212 may select an advertisement that is targeted to a family. Or, for example, if the group of identified users includes only adults (both male and female), then the advertisement selection platform 212 may select a generic advertisement to be targeted to the group of users.

Advertisement selection platform 212 may then provide the targeted advertisement to the advertisement application 198 in the computing device 12. In one set of operations performed by the disclosed technology, advertisement application 198 receives the targeted advertisement from the advertisement selection platform 212 and inserts the targeted advertisement into the multimedia content being streamed to the user during a pre-programmed time interval that has been allocated for displaying an advertisement to the user. The targeted advertisement may then be displayed to the user at the pre-programmed time interval while the user views the multimedia content, via the display module 202. In one embodiment, the targeted advertisement may be displayed to the user via the audiovisual device 16 connected to the computing device 12.

In another set of operations performed by the disclosed technology, advertisement application 198 may also automatically customize the targeted advertisement received from the advertisement selection platform 212 to generate a customized advertisement for the user, prior to displaying the targeted advertisement to the user. For example, suppose the advertisement application 198 receives a targeted advertisement for a branded watch from the advertisement selection platform 212. The advertisement selection platform 21 may automatically customize the targeted advertisement for the branded watch received from the advertisement selection platform 212 to generate a customized advertisement for the user. In one embodiment, the advertisement application 198 may utilize the user-specific information (e.g., illustrated in “Table-1”) to generate the customized advertisement for the user. The operations performed by the advertisement application 198 to generate a customized advertisement are discussed in detail below.

In one embodiment, the code for an advertisement may be implemented as a configuration file. In one example, the configuration file may be implemented as an Extensible Markup Language (XML) configuration file. An exemplary data structure of a configuration file associated with an advertisement, is illustrated below:

<AdDescription>
<AdName> Brand X Watch </AdName>
<AdVideoSream> http://www.BrandXAd.com/BrandX-video.wmv
</AdVideoStream>
<AdConfigurableParameters>

<MainPlayer> http://www.BrandXAd.com/MainplayerImage.jpg
</MainPlayer >
<Audience> http://www.BrandXAd.com/AudienceImage.jpg
</Audience>
<Background> http://www.BrandXAd.com/BackgroundImage.jpg
</Background>

</AdConfigurableParameters>
<AdNonConfigurableParameters>

<AdImage> BrandX.jpg </AdImage>

</AdNonConfigurableParameters>
</AdDescription>

The data structure illustrated above describes an exemplary configuration file associated with a “Brand X Watch” advertisement. “AdDescription” is a tag that describes the advertisement, “AdName” is a tag that specifies the name of the advertisement, “AdVideoStream” is a tag that specifies a link to the actual video stream (BrandX-video.wmv) associated with the advertisement, “AdConfigurableParameters” is a tag that represents one or more configurable parameters in the configuration file and “AdNonConfigurableParameters” is a tag that represents one or more non-configurable parameters in the configuration file.

In the illustrated example, the configurable parameter, “MainPlayer”, includes a link to a photo image (MainplayerImage.jpg) and the configurable parameter, “Audience”, includes a link to a photo image (AudienceImage.jpg). As described herein, “MainPlayer” may refer to, for example, a primary entity in the advertisement and “Audience” may refer to one or more secondary entities in the advertisement. For example, if the advertisement is for a “Brand X Watch” as described in the configuration file above and the video stream associated with the advertisement depicts a golfer wearing a Brand X watch while playing golf in a golf park with one or more other players, the golfer is the primary entity or the “MainPlayer” in the advertisement, while the other players are the secondary entities or the “Audience” in the advertisement. Similarly, the configurable parameter, “Background” may include a link to a background image (BackgroundImage.jpg). In the example of the “Brand X Watch” advertisement, the background image may include, for example, the golf park that is displayed in the advertisement.

As discussed above, the configuration file associated with an advertisement may also include one or more non-configurable parameters. In the example of the “Brand X Watch” advertisement discussed above, “AdImage” is a non-configurable parameter that may include, for example, a digital image (BrandX.jpg) of the watch displayed in the advertisement. It is to be appreciated that any number or types of configurable and non-configurable parameters may be specified in a configuration file associated with an advertisement, in other embodiments.

In one embodiment, the data represented by the configurable parameters in the configuration file associated with an advertisement may be automatically modified by the advertisement application 198 to generate a customized advertisement for the user. Advertisement application 198 may include a collection of pre-programmed modification rules that define the manner in which data represented by a configurable parameter in the configuration file may be modified. In one example, the modification rules may define a correlation between the data represented by a configurable parameter and the user-specific information derived from the user-specific information table (e.g., illustrated in “Table-1”), related to the user. The advertisement application 198 may modify the data represented by configurable parameters by automatically replacing the data represented by the configurable parameters with the user-specific information defined by the modification rules to generate a customized advertisement for the user.

For example, if the modification rules in the advertisement application 198 define a correlation between the data (“MainplayerImage.jpg”) represented by the configurable parameter, “MainPlayer” and a photo, video or 3D on-screen character representation (e.g., User1.jpg) of the user derived from the user-specific information table (e.g., illustrated in “Table-1”), then the advertisement application 198 may automatically modify the data represented by the configurable parameter, “MainPlayer” by automatically replacing the data represented by the configurable parameter (i.e., “MainplayerImage.jpg”) with the user-specific information (i.e., User1.jpg). Similarly, the data (“AudienceImage.jpg”) represented by the configurable parameter, “Audience” may automatically be replaced with a photo of the user's friends (e.g., friends.jpg) or the data (“BackgroundImage.jpg”) represented by the configurable parameter, “Background” may automatically be replaced with a photo of a park obtained from the user-specific information table related to the user (e.g., Yellowstonepark.jpg), in other examples.

The advertisement application 198 may then insert the generated customized advertisement into the multimedia content being streamed to the user during a pre-programmed time interval that has been allocated for displaying an advertisement to the user. The customized advertisement may be displayed to the user at the pre-programmed time interval while the user views the multimedia content, via the display module 202. The generation of a customized advertisement by displaying information about one or more aspects of the user's life based on the user-specific information related to the user as discussed above enables a user to feel more connected to the product being displayed in the advertisement and enhances the user's affinity to the product. In one embodiment, the user may also be rewarded with a coupon when the user views the customized advertisement so that the user is encouraged to view future customized advertisements that may be presented to the user. The customized advertisement may be displayed to the user via the audiovisual device 16 connected to the computing device 12. In one embodiment, the customized advertisements generated for a user may be stored in a customized advertisement database 200.

The above technique for generating a customized advertisement for a user may be applied to any type or category of advertisements that may be displayed to a user via the audiovisual device 16. For example, an advertisement for an automobile may be customized to show a user driving the automobile displayed in the advertisement, an advertisement for a pizza at a birthday party may be customized to replace the children and other people appearing in the party with the user's family, an advertisement for a song album may be customized to enable a user to hear the voice of a loved one singing a song from the album or an advertisement for a beverage may be customized to show an on-screen character representation of the user's friends drinking the beverage.

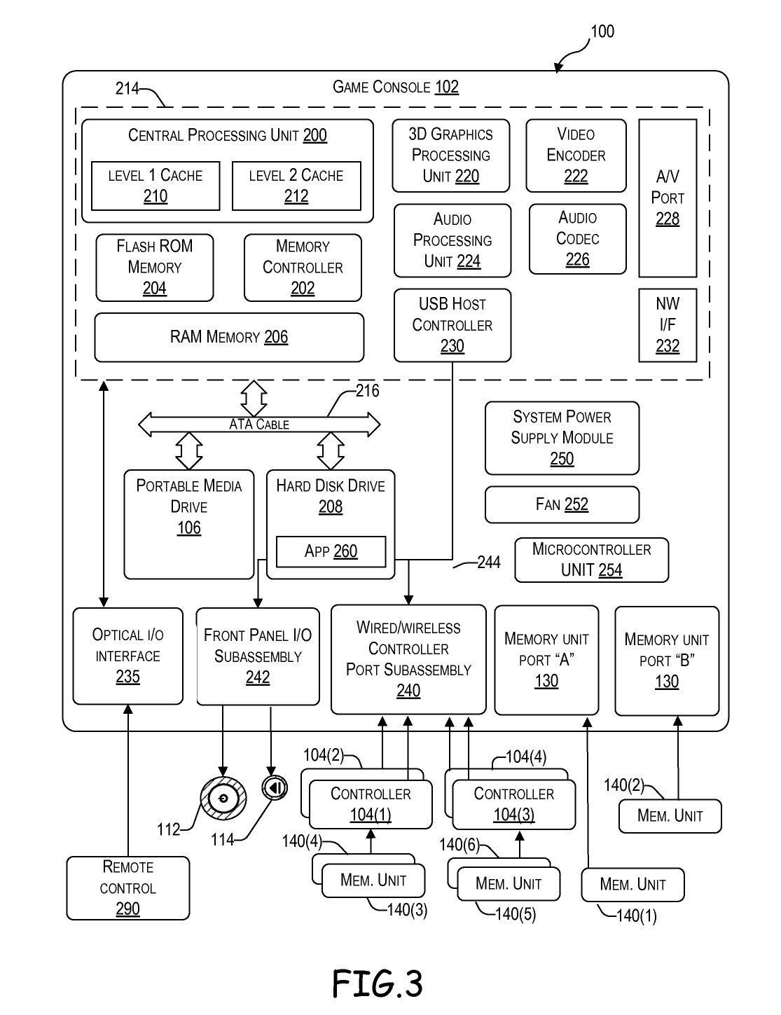

FIG. 3 illustrates an example of a computing device 100 that may be used to implement the computing device 12 of FIGS. 1-2. In one embodiment, the computing device 100 of FIG. 3 may be a multimedia console 100, such as a gaming console. As shown in FIG. 3, the multimedia console 100 has a central processing unit (CPU) 200, and a memory controller 202 that facilitates processor access to various types of memory, including a flash Read Only Memory (ROM) 204, a Random Access Memory (RAM) 206, a hard disk drive 208, and portable media drive 106. In one implementation, CPU 200 includes a level 1 cache 210 and a level 2 cache 212, to temporarily store data and hence reduce the number of memory access cycles made to the hard drive 208, thereby improving processing speed and throughput.

CPU 200, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 200, memory controller 202, ROM 204, and RAM 206 are integrated onto a common module 214. In this implementation, ROM 204 is configured as a flash ROM that is connected to memory controller 202 via a PCI bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 106 are shown connected to the memory controller 202 via the PCI bus and an AT Attachment (ATA) bus 216. However, in other implementations, dedicated data bus structures of different types can also be applied in the alternative.

A graphics processing unit 220 and a video encoder 222 form a video processing pipeline for high speed and high resolution (e.g., High Definition) graphics processing. Data are carried from graphics processing unit 220 to video encoder 222 via a digital video bus (not shown). An audio processing unit 224 and an audio codec (coder/decoder) 226 form a corresponding audio processing pipeline for multi-channel audio processing of various digital audio formats. Audio data are carried between audio processing unit 224 and audio codec 226 via a communication link (not shown). The video and audio processing pipelines output data to an A/V (audio/video) port 228 for transmission to a television or other display. In the illustrated implementation, video and audio processing components 220-228 are mounted on module 214.

FIG. 3 shows module 214 including a USB host controller 230 and a network interface 232. USB host controller 230 is shown in communication with CPU 200 and memory controller 202 via a bus (e.g., PCI bus) and serves as host for peripheral controllers 104(1)-104(4). Network interface 232 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 3, console 102 includes a controller support subassembly 240 for supporting four controllers 104(1)-104(4). The controller support subassembly 240 includes any hardware and software components needed to support wired and wireless operation with an external control device, such as for example, a media and game controller. A front panel I/O subassembly 242 supports the multiple functionalities of power button 112, the eject button 114, as well as any LEDs (light emitting diodes) or other indicators exposed on the outer surface of console 102. Subassemblies 240 and 242 are in communication with module 214 via one or more cable assemblies 244. In other implementations, console 102 can include additional controller subassemblies. The illustrated implementation also shows an optical I/O interface 235 that is configured to send and receive signals that can be communicated to module 214.

MUs 140(1) and 140(2) are illustrated as being connectable to MU ports “A” 130(1) and “B” 130(2) respectively. Additional MUs (e.g., MUs 140(3)-140(6)) are illustrated as being connectable to controllers 104(1) and 104(3), i.e., two MUs for each controller. Controllers 104(2) and 104(4) can also be configured to receive MUs (not shown). Each MU 140 offers additional storage on which games, game parameters, and other data may be stored. In some implementations, the other data can include any of a digital game component, an executable gaming application, an instruction set for expanding a gaming application, and a media file. When inserted into console 102 or a controller, MU 140 can be accessed by memory controller 202. A system power supply module 250 provides power to the components of gaming system 100. A fan 252 cools the circuitry within console 102.

An application 260 comprising machine instructions is stored on hard disk drive 208. When console 102 is powered on, various portions of application 260 are loaded into RAM 206, and/or caches 210 and 212, for execution on CPU 200, wherein application 260 is one such example. Various applications can be stored on hard disk drive 208 for execution on CPU 200.

Gaming and media system 100 may be operated as a standalone system by simply connecting the system to monitor 150 (FIG. 1), a television, a video projector, or other display device. In this standalone mode, gaming and media system 100 enables one or more players to play games, or enjoy digital media, e.g., by watching movies, or listening to music. However, with the integration of broadband connectivity made available through network interface 232, gaming and media system 100 may further be operated as a participant in a larger network gaming community.

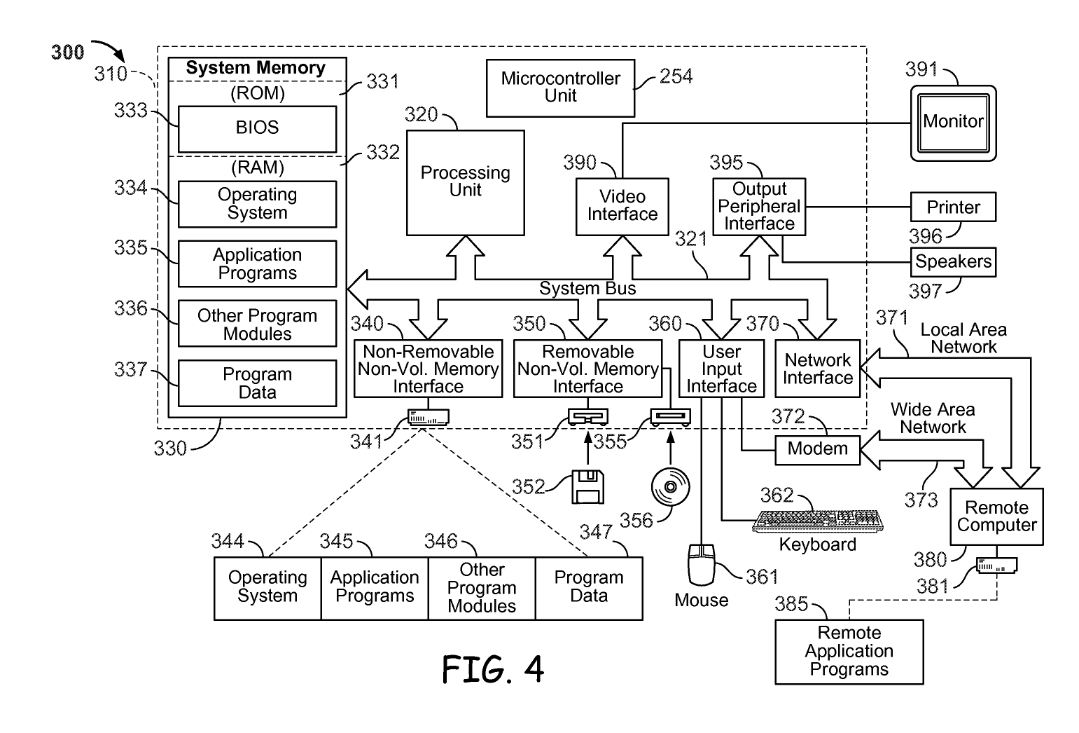

FIG. 4 illustrates a general purpose computing device which can be used to implement another embodiment of computing device 12. With reference to FIG. 4, an exemplary system for implementing embodiments of the disclosed technology includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 4 illustrates operating system 334, application programs 335, other program modules 336, and program data 337.

The computer 310 may also include other removable/non-removable, volatile/nonvolatile computer storage media. By way of example only, FIG. 4 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 4, provide storage of computer readable instructions, data structures, program modules and other data for the computer 310. In FIG. 4, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 20 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 390.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 4. The logical connections depicted in FIG. 4 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 4 illustrates remote application programs 385 as residing on memory device 381. It will be appreciated that the network connections shown are exemplary and other means of establishing a communications link between the computers may be used.

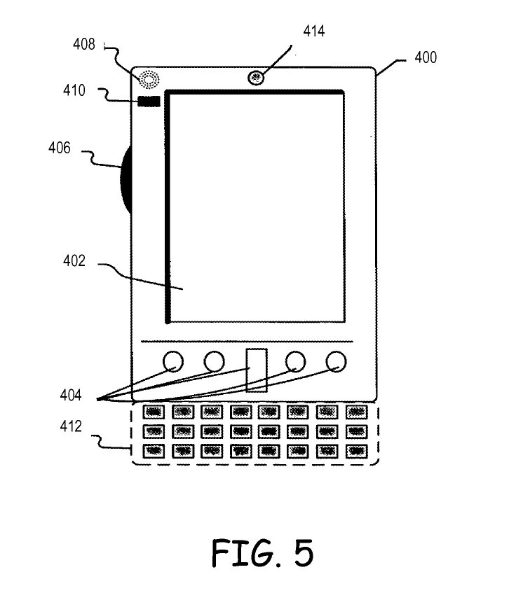

FIG. 5 illustrates another embodiment of the computing device for implementing the operations of the disclosed technology. In one embodiment, the computing device may be a mobile computing device 400, which may include, but is not limited to, a cell phone, a web-enabled smart phone, a personal digital assistant, a palmtop computer, a laptop computer or any similar device which communicates via wireless signals. Mobile computing device 400 may include both input elements and output elements. Input elements may include a touch screen display 402 and input buttons 404 that allow a user to enter information into the mobile computing device 400. Mobile computing device 400 also incorporates a side input element 406 for enabling further user input. Side input element 406 may be a rotary switch, a button, or any other type of manual input element. In alternative embodiments, mobile computing device 400 may incorporate more or less input elements. For example, display 402 may not be a touch screen in some embodiments. Mobile computing device 400 may also include an optional keypad 412. Optional keypad 412 may be a physical keypad or a “soft” keypad generated on the touch screen display. Yet another input device that may be integrated into mobile computing device 400 is an on-board camera 414.

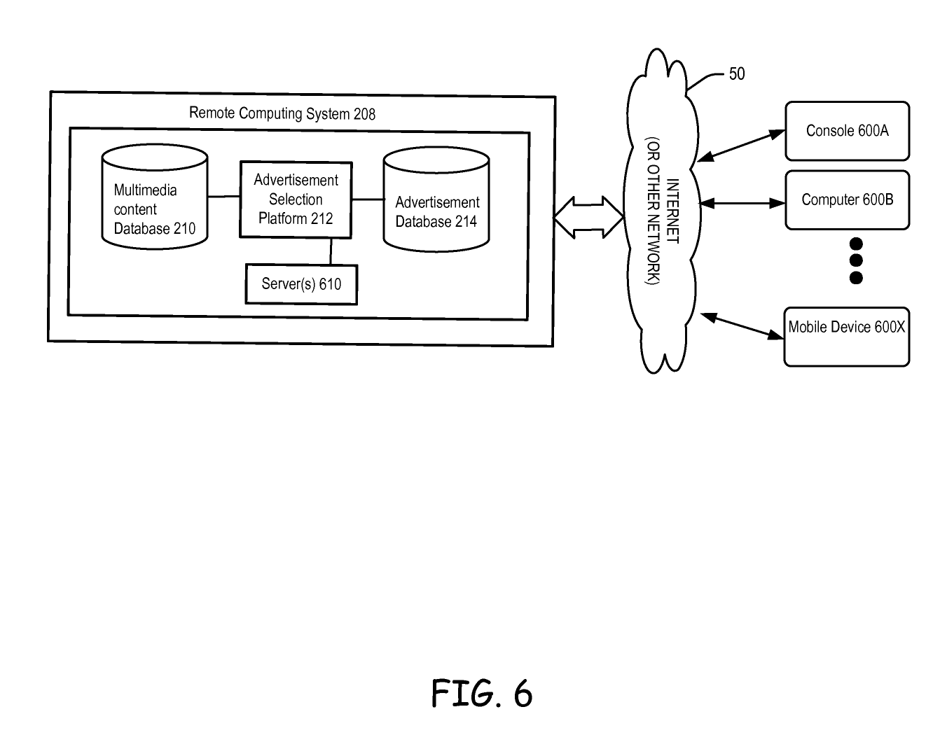

FIG. 6 is a block diagram of a system for implementing the present technology. FIG. 6 illustrates multiple processing devices 600A, 600B . . . 600X that are coupled to a network 50 and can communicate with a remote computing system 208. In one embodiment, network 50 comprises the Internet, though other networks such as LAN or WAN are contemplated. The processing devices 600A, 600B . . . 600X may include a gaming and media console, a personal computer, or one or more mobile devices such as, for example, a cell phone, a web-enabled smart phone, a personal digital assistant, a palmtop computer or a laptop computer. Processing devices 600A, 600B . . . 600X can include the devices of FIGS. 1-5. The remote computing system 208 may include one or more server(s) 610 capable of receiving information from and transmitting information to the processing devices 600A, 600B . . . 600X and provides a collection of services that applications, such as application 190 running on processing devices 600A, 600B . . . 600X may invoke and utilize. For example, the server(s) 610 in the remote computing system 208 may manage a plurality of multiplayer activities concurrently by aggregating events from users executing one or more applications in the processing devices, 600A, 600B . . . 600X.

In one embodiment, the remote computing system may represent a content provider or an advertiser. In one embodiment, and as discussed in FIG. 2, remote computing system 208 includes a multimedia content database 210, an advertisement database 214 and an advertisement selection platform 212. In one embodiment, remote computing system 208 may provide a targeted advertisement to one or more of the processing devices 600A, 600B . . . 600X. As discussed in FIG. 2, a display module in the processing devices 600A, 600B . . . 600X may display the targeted advertisement to the users via a display module.

The hardware devices of FIGS. 1-6 discussed above can be used to implement a system that provides a targeted advertisement to a user based on identifying the multimedia content viewed by a user, the user's identity and the user's emotional response to the viewed multimedia content, in one embodiment. In another embodiment, the hardware devices of FIGS. 1-6 can also be used to implement a system that generates a customized advertisement for the user by utilizing user-specific information associated with the user.

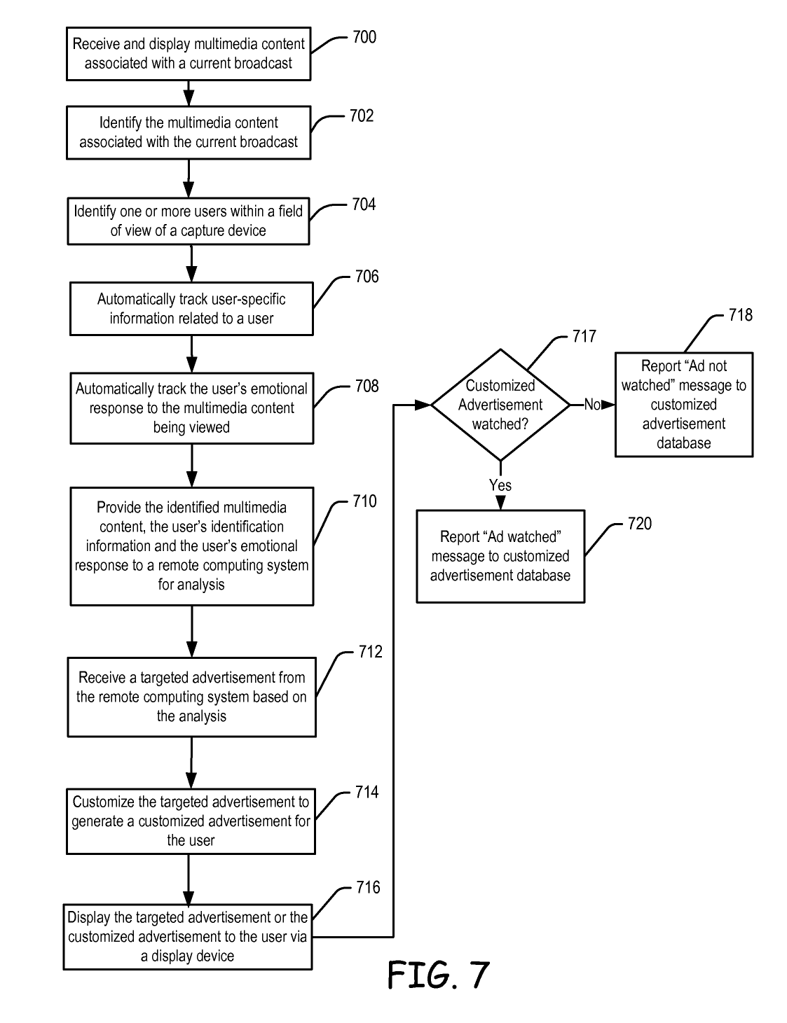

FIG. 7 is a flowchart describing one embodiment of a process for providing targeted and/or customized advertisements. In one embodiment, the steps of FIG. 7 may be performed by software modules in the facial recognition engine 192 and the advertisement customization module 196. In step 700, multimedia content associated with a current broadcast is received and displayed. As discussed in FIG. 2, multimedia content can include any type of audio, video, and/or image media content received from media content sources such as content providers, broadband, satellite and cable companies, advertising agencies the internet or video streams from a web server. For example, multimedia content can include recorded video content, video-on-demand content, television content, television programs, advertisements, commercials, music, movies, video clips, and other on-demand media content. In one embodiment, the multimedia content may be received and displayed by the audiovisual device 16 connected to the computing device 12. In an alternate embodiment, the multimedia content may be received at the computing device 12, which may then display the multimedia content via the audiovisual device 16 to the users.

In step 702, multimedia content associated with the current broadcast is identified. In one embodiment, the multimedia content may be identified to be a television program. The multimedia content may be identified by the audio visual device 16 connected to the computing device 12, in one embodiment. Alternatively, the multimedia content may also be identified by the computing device 12. The identification of the content can be based on metadata with the content or program guides.

In step 704, one or more users in a field of view of the capture device 20 connected to the computing device 12 are identified. In one embodiment, the computing device 12 may determine a user's identity by receiving input from the user identifying their identity. In another embodiment, and as discussed in FIG. 2, facial recognition engine 192 in the computing device may also perform the identification of users using data from a depth camera and/or data from a visual image camera. In step 704, the user's identification information may also be anonymized. As discussed in FIG. 2, in one embodiment, a user's privacy concerns are met by anonymizing the user's profile information prior to implementing the disclosed technology.

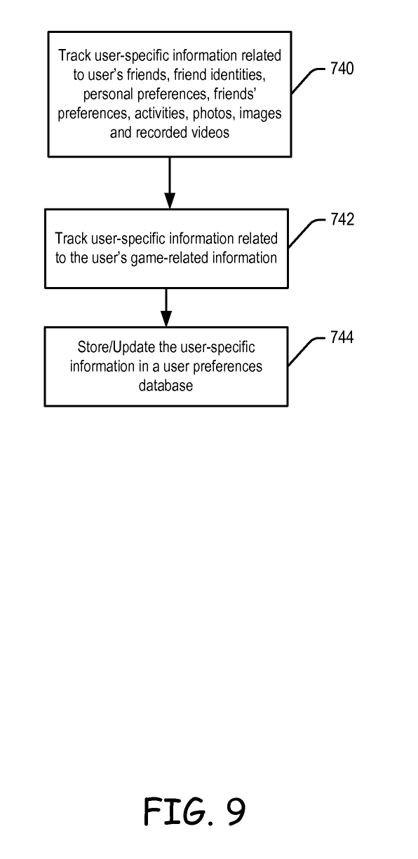

In step 706, user-specific information for a user identified by the computing device is automatically tracked. In one embodiment, computing device 12 may automatically track the user-specific information related to the user. In one embodiment, and as discussed in FIG. 2, the user-specific information is stored in the user preferences database 204. The technique by which user-specific information is tracked for a user is discussed in FIG. 9.

In step 708, a user's emotional response to the multimedia content being viewed is automatically tracked by the capture device 20. In one example, and as discussed in FIG. 2, data (depth data or visual image data) from the capture device 20 may be used to detect facial expressions and/or vocal responses such as smiles, laughter, cries, frowns, yawns or applauses from the user, while the user views the multimedia content and the user's gestures and movements while viewing the multimedia content.

In step 710, the identified multimedia content (obtained in step 702), the user's identification information (obtained in step 704) and the user's emotional response (obtained in step 708) are provided to a remote computing system for analysis. As discussed in FIG. 2, the remote computing system may represent a content provider or an advertiser, in one embodiment. In one embodiment, the user's identification information is protected, encrypted or anonymized prior to providing the information to the remote computing system for analysis.

In step 712, the computing device 12 receives a targeted advertisement from the remote computing system 208 based on the analysis. As discussed in FIG. 2, in one embodiment, the advertisement selection platform 212 in the remote computing system 208 may select an advertisement to be displayed to a user based on analyzing the identified multimedia content, the user's identification information and the user's emotional response received from the computing system 12 and choosing the advertisement that is closest in content.

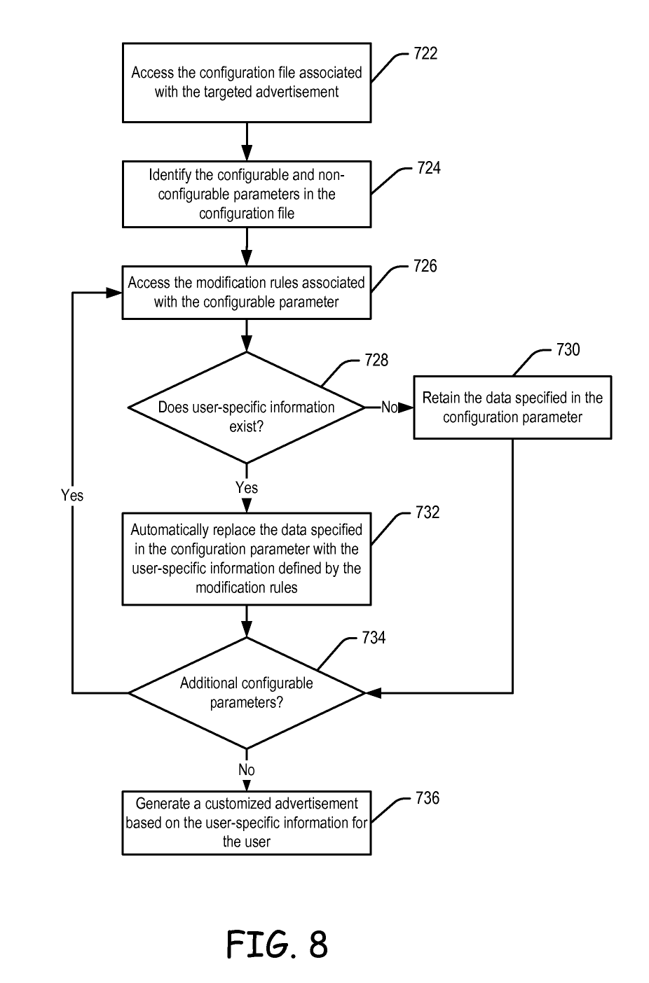

In step 714, the computing system may further customize the targeted advertisement received from the remote computing system to generate a customized advertisement for the user. The technique by which a customized advertisement is generated for a user is discussed in FIG. 8. In step 716, the targeted advertisement or the customized advertisement is displayed to the user, via the audiovisual device 16 connected to the computing device 12.

In step 717, it is determined if the user actually watched the targeted advertisement or the customized advertisement. In one embodiment, the user's movements, gestures and facial expressions within a field of view of the capture device are identified during a pre-programmed time interval in the streamed multimedia content that has been allocated for displaying an advertisement to the user to determine if the user watched the advertisement. In one embodiment, the computing device 12 may determine if the user watched the advertisement by determining the percentage of time that the user was in the field of view of the capture device while watching the advertisement or if the user faced the audio visual device 16 while watching the advertisement, the user's posture (such as leaning forward) while watching the advertisement or by the user's facial expression while watching the advertisement. If it is determined that the user did not watch the advertisement, then in step 718, the advertisement application 198 reports an “Advertisement not watched” message associated with the advertisement, to the customized advertisement database 200. If it is determined that the user watched the advertisement, then in step 719, the advertisement application 198 reports an “Advertisement watched” message associated with the advertisement to the customized advertisement database 200. In one embodiment, the user may also be rewarded with a coupon when the user watches the customized advertisement so that the user is encouraged to watch future customized advertisements that may be presented to the user.

FIG. 8 is a flowchart describing another embodiment of a process for performing the operations of the disclosed technology. FIG. 8 describes one embodiment of a process by which a customized advertisement is generated for a user (e.g., more details of step 714 of FIG. 7). Upon receiving a targeted advertisement for a user as described in step 712 of FIG. 7, a configuration file associated with the targeted advertisement is accessed in step 722. The data structure for an exemplary configuration file associated with an advertisement is provided above.

In step 724, the configurable parameters and the non-configurable parameters in the configuration file are identified. In one embodiment, the configurable parameters in the configuration file associated with an advertisement may be modified to generate a customized advertisement for the user. In step 726, the modification rules associated with a configurable parameter is accessed. The modification rules define the manner in which data represented by a configurable parameter in the configuration file may be modified. As discussed above with respect to FIG. 2, the modification rules define a correlation between the data represented by a configurable parameter and the user-specific information derived from the user-specific information table (e.g., illustrated in “Table-1”), associated with the user.

In step 728, it is determined if user-specific information corresponding to the data represented by the configurable parameter exists. If no user-specific information exists, then the data represented by the configurable parameter is not modified in step 730. If user-specific information exists, then the data represented by the configurable parameter is modified by automatically replacing the data represented by the configurable parameters with the user-specific information defined by the modification rules, in step 732.

In step 734, it is determined if there are any additional configurable parameters in the configurable file associated with the advertisement. If there are additional configurable parameters, then the modification rules associated with the configurable parameter is accessed as discussed in step 724. If there are no additional configurable parameters in the configuration file, then a customized advertisement based on the user-specific information is generated for the user in step 736. In step 736, a customized advertisement is generated in which all (or a subset of) the configurable parameters in the configuration file associated with the advertisement have been replaced with the user-specific information related to the user. In one example, the customized advertisement includes video, audio and/or still images from the original targeted advertisement in addition to new video, images or audio added to customize the content of the advertisement. The customized advertisement is inserted into the multimedia content being streamed to the user during a pre-programmed time interval that has been allocated for displaying an advertisement to the user. The customized advertisement displays information about one or more aspects of the user's life in the advertisement based on the user-specific information related to the user, thereby enhancing the user's affinity to the product being displayed in the advertisement. In one embodiment, the customized advertisement is displayed to the user at the pre-programmed time interval while the user views the multimedia content, via the audiovisual device 16 connected to the computing device 12.

In another embodiment, the advertisement received in step 712 is an executable. One example of an executable is a Flash file (SWF format). The executable can include a set of hooks or an API that define how Advertisement Customization Module 196 can add one or more images, videos or sounds to an advertisement in order to customize the advertisement.

FIG. 9 is a flowchart describing an example embodiment of a process for by which user-specific information related to a user is tracked (e.g., more details of step 706 of FIG. 7). Upon identifying one or more users in a field of view of the capture device as described in step 704 of FIG. 7, user-specific information related to a user is tracked by the computing device in step 706 of FIG. 7. In one embodiment, and as discussed in FIG. 2, computing device 12 may perform the tracking of the user-specific information on a periodic basis or at pre-programmed intervals of time which may be determined by the computing device 12.

In step 740 of FIG. 9, the computing device tracks user-specific information related to the user's expressed preferences, the user's friends' list, the user's stated preferred activities, the user's friends' expressed preferences, the user's social groups and other user created content, such as the user's photos, images and recorded videos. In one embodiment, the user-specific information may be obtained from one or more data sources such as the user's social networking sites, address book, email data, Instant Messaging data, user profiles or other sources on the Internet. In one embodiment, the computing device may also track information about the user's physical presence, such as the user's current location based on the user-specific information. In step 742, user-specific information related to the user's game-related information is tracked based on one or more game applications executing in the user's computing device. Game-related information may include information about the user's on-screen character representation, the user's statistics for particular games, achievements acquired for particular games, and/or other game specific information. In step 744, the user-specific information related to the user is stored and/or updated in the user preferences database 204 in the user's computing device. In one embodiment, the user preferences database 204 may be implemented as a table with fields representing various types of user-specific information such as friend identities, personal preferences, friends preferences, photos, images, recorded videos and game-related information (e.g., illustrated in “Table-1”) related to a user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

What is claimed is:

1. A computer-implemented method for generating a customized advertisement for one or more users viewing multimedia content via an audiovisual device, the computer-implemented method comprising:
receiving and displaying multimedia content associated with a current broadcast;
identifying one or more of the users in a field of view of a capture device connected to a computing device, the identifying comprising uniquely identifying the one or more users based on capturing at least one of a visual image and a depth image associated with the one or more users;
automatically tracking user-specific information related to the one or more users viewing the multimedia content based on the identifying;
providing the user-specific information to a remote computing system for analysis;
receiving a targeted advertisement for the one or more users from the remote computing system based on the analysis;
automatically generating a customized advertisement for the one or more users based on the targeted advertisement; and
displaying the customized advertisement to the one or more users during a pre-programmed time interval, via an audiovisual device connected to the computing device.

2. The computer-implemented method of claim 1, further comprising:
automatically tracking an emotional response of the one or more users to the multimedia content, the providing the user-specific information includes providing the emotional response of the one or more users to the multimedia content to the remote computing system, the targeted advertisement is targeted based on the provided user-specific information and the emotional response, the generating the customized advertisement includes customizing the received targeted advertisement based on the user-specific information and the emotional response.

3. The computer-implemented method of claim 2, wherein automatically tracking the emotional response of the one or more users to the multimedia content further comprises:
automatically tracking at least one of a movement, gesture, facial expression or a vocal response of the one of more users to the viewed multimedia content.

4. The computer-implemented method of claim 2, wherein:
the automatically tracking the user-specific information for the one or more users comprises tracking information about the one or more users friend's list, the user's stated preferred activities, the user's friends' expressed preferences, the user's social groups, photos, images, recorded videos, the user's physical presence, demographic information and game-related information;
the automatically tracking the emotional response of the one or more users comprises tracking at least one of a movement, gesture, facial expression or a vocal response of the one of more users to the viewed multimedia content;
the generating the customized advertisement for the one or more users comprises accessing a configuration file associated with the targeted advertisement, identifying one or more configurable parameters and one or more non-configurable parameters in the configuration file, accessing modification rules associated with the one or more configurable parameters and automatically generating a customized advertisement for the one or more users based on at least the modification rules and the user-specific information.

5. The computer-implemented method of claim 1, wherein the user-specific information related to the one or more users comprises one or more of friend identities, personal preferences, friends' preferences, activities, photos, images, recorded videos, demographic information and game-related information associated with the one or more users.

6. The computer-implemented method of claim 1, further comprising:
anonymizing the information identifying the one or more users prior to automatically tracking the emotional response of the one or more users to the viewed multimedia content.

7. The computer-implemented method of claim 1, wherein automatically generating the customized advertisement for the one or more users is based on the user-specific information generated for the one or more users.

8. The computer-implemented method of claim 1, wherein automatically generating the customized advertisement for the one or more users further comprises:
accessing a configuration file associated with the targeted advertisement;
identifying one or more configurable parameters and one or more non-configurable parameters in the configuration file; and
accessing modification rules associated with the one or more configurable parameters, wherein the modification rules define a correlation between the data represented by the one or more configurable parameters and the user-specific information related to the one or more users.

9. The computer-implemented method of claim 8, wherein accessing the modification rules associated with the one or more configurable parameters further comprises:
identifying if the user-specific information specified in the modification rules associated with the one or more configurable parameters exists; and
automatically replacing the data represented by the one or more configurable parameters with the user-specific information defined by the modification rules to generate the customized advertisement for the one or more users.

10. The computer-implemented method of claim 1, further comprising:
displaying the targeted advertisement to the one or more users during a pre-programmed time interval, via an audiovisual device connected to the computing device.

11. One or more processor readable storage devices having processor readable code embodied on said one or more processor readable storage devices, the processor readable code for programming one or more processors to perform a method comprising:
automatically tracking user-specific information related to one or more users viewing multimedia content associated with a current broadcast;
receiving a targeted advertisement for the one or more users from a remote computing system;
accessing a configuration file associated with the targeted advertisement;
identifying one or more configurable parameters and one or more non-configurable parameters in the configuration file;
accessing modification rules associated with the one or more configurable parameters;
automatically generating a customized advertisement for the one or more users based on at least the modification rules and the user-specific information; and
displaying the customized advertisement to the one or more users during a pre-programmed time interval, via an audiovisual device.

12. One or more processor readable storage devices according to claim 11, wherein the modification rules define a correlation between the data represented by the one or more configurable parameters and the user-specific information associated with the one or more users.

13. One or more processor readable storage devices according to claim 11, wherein accessing the modification rules associated with the one or more configurable parameters further comprises:
identifying if the user-specific information specified in the modification rules associated with the one or more configurable parameters exists; and
automatically replacing the data represented by the one or more configurable parameters with the user-specific information defined by the modification rules to generate the customized advertisement for the one or more users.

14. One or more processor readable storage devices according to claim 11, wherein the user-specific information for the one or more users comprises one or more of the user's friend's list, the user's stated preferred activities, the user's friends' expressed preferences, the user's social groups, photos, images, recorded videos, demographic information and game-related information associated with the one or more users.

15. One or more processor readable storage devices according to claim 11, wherein receiving a targeted advertisement for the one or more users further comprises:
automatically identifying one or more of the users viewing the multimedia content in a field of view of a capture device connected to a computing device; and
automatically tracking an emotional response of the one or more users to the multimedia content, in the field of view.

16. One or more processor readable storage devices according to claim 15, wherein receiving a targeted advertisement for the one or more users is further based on information identifying the multimedia content viewed by the one or more users, information identifying the one or users and the emotional response of the one or more users to the viewed multimedia content.

17. One or more processor readable storage devices according to claim 15, wherein automatically tracking the emotional response of the one or more users to the multimedia content further comprises:
automatically tracking at least one of a movement, gesture, facial expression or a vocal response of the one of more users to the viewed multimedia content.

18. An apparatus for generating a customized advertisement for one or more users, comprising:
a depth camera; and
a computing device connected to the depth camera to receive multimedia content associated with a current broadcast, identify one or more users in a field of view of a capture device, track user-specific information for the one or more users viewing the multimedia content, identify an emotional response of the one or more users to the multimedia content, receive a targeted advertisement for the one or more users based on at least one of information identifying the multimedia content viewed by the one or more users, information identifying the one or more users and the emotional response of the one or more users, and generate a customized advertisement for the one or more users based on the targeted advertisement and the user-specific information associated with the one or more users.

19. The apparatus of claim 18, wherein:
the computing device identifies the emotional response of the one or more users based on identifying a movement, gesture or a facial expression of the one or more users at run time.

20. The apparatus of claim 18, wherein:
the computing device identifies the emotional response of the one or more users based on identifying a vocal quality of the one or more users at run time.
